(19) United States
(12) Patent Application Publication
(10) Pub. No.: US 2026/0248141 A1
(43) Pub. Date: Aug. 27, 2026

(54) BIODEGRADABLE SEED COATING COMPOSITION AND A PROCESS FOR MANUFACTURING THE SAME

(71) Applicant: NATURATECH GmbH, Mägenwil (CH)

(72) Inventors: Marija Kondres, Belp (CH); Selver Yavuz, Gerlafingen (CH); Oliver Maass, München (DE)

(73) Assignee: NATURATECH GmbH, Mägenwil (CH)

(21) Appl. No.: 19/061,648

(22) Filed: Feb. 24, 2025

(51) Int. Cl. A01N 65/42; A01N 25/04; A01N 25/22; A01N 37/44; A01N 65/08; A01N 65/40; A01P 21/00

(52) U.S. Cl. CPC A01N 65/42; A01N 25/04; A01N 25/22; A01N 37/44; A01N 65/08; A01N 65/40; A01P 21/00

(57) ABSTRACT

The present invention relates to a biodegradable seed coating composition and a process to enhance seed protection, growth promotion, sustainability, and environmental compatibility. The composition comprises Polyhydroxybutyrate-co-valerate (PHBV), a natural antimicrobial agent like chitosan, plant-derived growth promoters such as aloe vera extract, a micronutrient complex, additives and a carrier such as purified water. The process for manufacturing the coating ensures precise integration of components under controlled conditions, maintaining temperatures below 70° C. The resulting coated seed product offers a shelf life of 5-7 years, germination rates above 90%, and moisture stability within ±2%.

### FIELD OF THE INVENTION

The present invention relates to the field of agricultural technology, and more particularly to seed coating composition and a process for manufacturing the same. Specifically, the invention relates to biodegradable seed coating composition and process for manufacturing the seed coating composition and applying such coating composition over seeds, providing enhanced seed protection, biodegradability, growth promotion and shelf life.

### BACKGROUND OF THE INVENTION

Modern agriculture relies heavily on seed treatment technologies to protect seeds during storage and enhance their performance during germination and early growth stages. Seeds are the cornerstone of agricultural production, playing an essential role in ensuring food security by providing the foundation for plant propagation and crop production.

As the global agricultural industry faces increasing pressure to meet the growing demands of an expanding population, the need to maximize agricultural productivity through innovative technologies becomes ever more critical.

Seed coating technologies have emerged as an important solution to improve seed performance, enhance plant growth, and protect seeds from environmental stressors, harsh environmental or unfavorable climatic conditions, pathogens, and pests, fungi, bacteria. These coatings typically comprise materials that form a protective layer around the seed, offering benefits such as improved seedling vigor, enhanced germination rates, and protection against soil-borne diseases.

However, despite their benefits, traditional seed coatings are often formulated with synthetic materials and petrochemical-derived substances that present serious environmental and ecological concerns. These conventional coatings primarily rely on synthetic polymers, chemical fungicides, pesticides, and other artificial compounds that, while effective in the short term, pose significant long-term risks to the environment.

Non-biodegradable materials used in these coatings contribute to the accumulation of micro plastics in soil, leading to soil pollution and potential harm to soil organisms. Over time, these materials do not break down or degrade in a natural way, creating lasting environmental hazards that can affect soil health, biodiversity, and ecosystem balance.

In addition to environmental concerns, the use of toxic chemical agents in seed coatings, such as synthetic fungicides and pesticides and other synthetic polymers like microplastic when released in environment, raises significant questions regarding their safety. These chemicals can have harmful effects on beneficial soil organisms, including microorganisms essential for nutrient cycling and the overall health of the soil ecosystem.

Moreover, they may contribute to the decline of pollinators and other non-target species, exacerbating the already critical problem of biodiversity loss. Further complicating this issue are increasingly stringent regulatory standards that seek to limit or prohibit the use of harmful chemicals in agricultural practices, especially as consumer demand for organic and sustainably produced food grows.

Traditional seed coating technologies often involve the use of synthetic polymers, chemical pesticides, fungicides, and non-biodegradable materials. These coatings, made from petrochemical-based substances like PVC and polyurethane, provide protection but persist in the environment, contributing to soil contamination and micro plastic pollution.

The chemical agents, such as fungicides and pesticides, help prevent seed losses but can harm ecosystems, including beneficial microbes and pollinators.

Additionally, non-biodegradable materials contribute to long-term pollution, negatively affecting soil health and water quality. These practices rely on non-renewable resources, increasing the carbon footprint of agriculture, and raise concerns about sustainability.

The synthetic polymers used in conventional seed coatings do not biodegrade readily, leading to their accumulation in the soil over time. This persistence results in long-lasting environmental harm, with micro plastics infiltrating soil and waterways. As synthetic coatings degrade slowly and incompletely, they release micro plastics that can persist for decades, contaminating the soil and potentially entering the food chain.

Chemical pesticides and fungicides incorporated into seed coatings may harm beneficial soil organisms such as earthworms, nitrogen-fixing bacteria, and other microorganisms that are essential for maintaining soil fertility and ecological balance.

Many seed coatings lack sufficient biodegradability, meaning that they do not break down in the environment within a reasonable timeframe. This limited breakdown results in long-term environmental pollution and adverse effects on soil health. Previous attempts to develop biodegradable seed coatings have often resulted in compromised performance, particularly in terms of storage stability and protection against microbial contamination.

Due to the aforementioned drawbacks, there is growing need for environmentally friendly seed coating compositions that address the limitations of conventional technologies.

The biodegradable seed coating compositions combine environmental sustainability with effective seed protection and growth promotion. The invention described herein offers a novel solution to these problems by utilizing biodegradable polymers, natural antimicrobial agents, plant-derived growth promoters, and other eco-friendly components to create a seed coating.

### OBJECTS OF THE INVENTION

The primary objects of the present invention is to provide an environmentally friendly seed coating that leaves no persistent residues or micro plastics in soil.

Another object of the invention is to achieve extended seed shelf life of up to 5-7 years while maintaining high germination rates.

Another object of the invention is to incorporate natural antimicrobial and growth-promoting compounds that enhance seed performance.

Yet another object of the invention is to develop a coating technology compatible with various seed types and environmental conditions.

### SUMMARY OF THE INVENTION

This summary is provided to introduce a selection of concepts in a simplified format that are further described in the detailed description of the disclosure. This summary is not intended to identify key or essential inventive concepts of the disclosure, nor is it intended for determining the scope of the disclosure.

The present invention discloses a biodegradable seed coating composition that combines natural polymers, antimicrobial agents, growth-promoting substances, and optional additives like natural colorants and antioxidants. The coating protects seeds from microbial damage, improves germination rates, and enhances early plant development while leaving no harmful residues in the environment.

In a preferred embodiment of the present invention, the seed coating composition consists of a base polymer polyhydroxybutyrate-valerate (PHBV) at 40% w/w, combined with antimicrobial agent like chitosan (20% w/w), aloe vera extract (10% w/w), water-soluble fertilizer (10% w/w), micronutrients (8% w/w), natural humectants (5% w/w), stabilizers (5% w/w), and natural colorants (2% w/w).

In an another embodiment of the present invention, the seed coating composition includes humectants, antioxidants, and natural colorants like chlorophyll enhance the coating's functionality, ensuring effective moisture management, oxidation prevention, and easy seed identification.

In an another preferred embodiment of the present invention, the process for manufacturing a biodegradable seed coating composition comprises the step of; dissolving chitosan in a 1-2 % acetic acid solution to form a chitosan solution; using stabilized aloe vera juice as a plant-derived growth promoter; dissolving PHBV (polyhydroxybutyrate-valerate) in ethyl acetate followed by homogenization to form a polymer base solution; stirring the chitosan solution into the PHBV solution to form a homogeneous mixture, after which stabilized aloe vera juice is added and homogenized for 10 minutes to ensure uniform distribution; stirring nitrogen fertilizer and micronutrients until all solids are completely dissolved; mixing humectants and antioxidants to regulate moisture and protect the composition from degradation, and an emulsifier is added to stabilize the mixture; homogenizing the mixture for 20 minutes to achieve a uniform consistency, after which the resulting composition is filled into airtight, UV-protected containers and stored at room temperature.

In another, PHBV may also be added with other solvents before homogenization step including—Acetic acid ethyl ester (acetyl acetate), Triethyl citrate, Butyl acetate or Isopropanol (IPA).

To further clarify the advantages and features of the method and system, a more particular description of the method and system will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### DETAILED DESCRIPTION OF THE INVENTION

The following description includes the preferred best mode of one embodiment of the present disclosure. It will be clear from this description of the disclosure that the disclosure is not limited to these illustrated embodiments but that the disclosure also includes a variety of modifications and embodiments thereto. Therefore, the present description should be seen as illustrative and not limiting. While the disclosure is susceptible to various modifications and alternative constructions, it should be understood, that there is no intention to limit the disclosure to the specific form disclosed, but, on the contrary, the disclosure is to cover all modifications, alternative constructions, and equivalents falling within the spirit and scope of the disclosure as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,“ and the like or the respective closed phrases ”consisting of,“ ”consists of, the like.

As used herein, the singular forms “a,” “an,” and “the” designate both the singular and the plural, unless expressly stated to designate the singular only.

The present invention discloses a biodegradable seed coating composition that combines natural polymers, antimicrobial agents, growth-promoting substances, and optional additives like natural colorants and antioxidants.

In an embodiment, the composition consists of a base polymer (PHBV) at 40% w/w, combined with antimicrobial chitosan (20% w/w), aloe vera extract (10% w/w), water-soluble fertilizer (10% w/w), micronutrients (8% w/w), natural humectants (5% w/w), stabilizers (5% w/w), and natural colorants (2% w/w).

The biodegradable polymer matrix, constitutes 35-45% of the total composition. The principal component of this matrix is Polyhydroxybutyrate-co-valerate (PHBV), a polymer specifically engineered for this application. The PHBV exhibits a molecular mass distribution ranging from 200,000 to 400,000 Daltons, with a carefully controlled hydrophobicity coefficient between 2.5 and 3.5. The polymer's crystalline fraction is maintained between 45-55%, while its thermal characteristics include a degradation threshold above 160° C. and a glass transition region between 2-5° C.

The primary antimicrobial agent that constitutes 15-25% of the weight, is high-molecular-weight chitosan. This chitosan has a deacetylation degree exceeding 85%, a molecular weight of 100,000-300,000 Da, and a particle size under 100 μm. Its solubility is optimized for a pH range of 5.5-6.5, providing robust protection against mold, bacteria, and fungi. comprising 15-25% of the total mass, centers on high-molecular-weight chitosan with precisely defined characteristics.

The chitosan may demonstrate a deacetylation threshold exceeding 85% and a molecular mass range of 100,000-300,000 Daltons. The material is processed to achieve particulate dimensions below 100 μm, optimizing its distribution and effectiveness within the coating matrix. The chitosan operates within a pH range of 5.5-6.5, providing comprehensive protection against fungal, bacterial, and mycological threats while maintaining complete biodegradability.

The growth promoters may constitute 18-24% of the weight and may incudes two components.

The first component may be a stabilized aloe vera extract complex, ranging from 8-12%, which is standardized to contain 0.5-1% aloin content and is maintained at a pH between 6.0-6.5. This extract is stabilized using a proprietary natural antioxidant matrix and protected through advanced encapsulation technology.

The second component comprises bioavailable nitrogen compounds, also present at 8-12%, featuring an amino acid profile exceeding 40% total content, with free amino nitrogen fraction above 8% and total nitrogen bioavailability exceeding 12%. The pH of this component is carefully optimized to 6.5-7.0 to ensure maximum effectiveness. These may be water soluble nitrogen fertilisers like Ammonium citrate which helps in germination phase of seeds.

The micronutrient delivery system, representing 7-10% of the total composition, incorporates three components.

Magnesium sulfate has a purity of over 99%, a particle size under 50 μm, and a moisture content below 0.5%.

Zinc oxide has a particle size under 20 μm, a surface area exceeding 40 m²/g, and a purity of over 99.9%.

Borax is technical grade, with a particle size under 45 μm and solubility above 4.5% at 20° C., ensuring optimal early plant development.

The additives constitute 7-13% of the weights and incudes multiple elements.

These include a natural humectant (4-6%) derived from vegetable glycerin with over 99.7% purity and moisture content below 0.5%.

The natural humectant may be biobased products including Propanediol, Sorbitol,

Aloe vera gel, Betaine, Hyaluronic acid, Honey extract, Trehalose, Vegetable glycerol from corn or coconut. or combination thereof.

The antioxidants may consists of groups selected from Tocopherol, Rosemary extract,

Caffeic acid, Polyphenols extracts derived green tea, Citric acid, Ferulic acid extracts derived from cereals, Flavonoids including quercetin, Anthocyanins extracts derived from berries and other plants.

The antioxidant complex (2-4%) combines L-ascorbic acid as the primary antioxidant with mixed tocopherols in a 3:1 ratio for enhanced oxidative stability.

A bio-based emulsifier (1-3%), derived from sustainable plant sources with an HLB value of 12-15 and a critical micelle concentration below 0.1%, stabilizes the mixture.

The emulsifiers may include from biodegradable emulsifiers including lecithin, saponins, sugar esters, vegetable based Mono-and diglycerides of fatty acids, rhamnolipids, guar gum, gum Arabic, pectin, Xanthan gum, Quillaja extracts, Soybean protein, faba bean protein and other biopolymers made of proteins and polysaccharides or combination thereof.

The natural colorant may be selected from group consist of Chlorophyll, Beta-carotene, Curcumin, Anthocyanins, Beetroot extract, Paprika extract including capsanthin, Spirulina extract, Saffron extract, Carmine extracts and other plant based extracts.

Furthermore, the composition includes a carrier which is purified water, which constitutes the remainder of the composition. It features a conductivity below 5 μS/cm, total dissolved solids under 10 ppm, and a pH range of 6.0-7.0, ensuring a consistent and stable liquid medium for the coating.

The manufacturing process for this advanced coating system involves a series of steps under quality control parameters. The steps may comprises as follows:

Step 1—Dissolving chitosan in a 1% acetic acid solution to form a chitosan solution using stabilized aloe vera juice as a plant-derived growth promoter;

Step 2—Dissolving PHBV (polyhydroxybutyrate-valerate) in ethyl acetate followed by homogenization to form a polymer base solution;

Step 3—Stirring the chitosan solution into the PHBV solution to form a homogeneous mixture, after which stabilized aloe vera juice is added and homogenized for 10 minutes to ensure uniform distribution;

Step 4—Stirring nitrogen fertilizer and micronutrients until all solids are completely dissolved; mixing humectants and antioxidants to regulate moisture and protect the composition from degradation, and an emulsifier is added to stabilize the mixture;

Step 5—Homogenizing the mixture for 20 minutes to achieve a uniform consistency, after which the resulting composition is filled into airtight, UV-protected containers and stored at room temperature.

The manufacturing process begins with the careful preparation of individual components under controlled conditions.

The PHBV preparation involves dissolution in an appropriate solvent while maintaining temperature control at 65-70° C., followed by homogenization at 5000 rpm to ensure uniform distribution.

In another embodiment, PHBV may also be added with solvents before homogenization step including—Acetic acid, ethyl ester (acetyl acetate), Triethyl citrate, Butyl acetate or Isopropanol (IPA).

The chitosan component undergoes separate preparation through dissolution in 1% acetic acid, with subsequent pH adjustment to 5.5-6.0 and filtration through a 0.45μm membrane to remove any particulate matter

The primary mixing phase involves the combination of PHBV and chitosan solutions under precisely controlled conditions. This process may be conducted at temperatures between 65-70° C. with a mixing speed of 1000-1500 rpm for a duration of 30 minutes.

The secondary incorporation phase follows, during which growth promoters and micronutrients may be carefully integrated into the mixture with an additional homogenization period of 20 minutes to ensure complete uniformity.

Quality Control Quality assurance is maintained through continuous monitoring of physical parameters throughout the production process. The viscosity is maintained between 200-400 cP, with pH levels carefully controlled between 5.5-6.5.

Performance testing includes comprehensive evaluation of coating uniformity, adhesion strength, moisture resistance, and biodegradability assessment.

### Application Methods

Seed Preparation: Prior to coating application, seeds may undergo thorough preparation to ensure optimal coating adhesion and performance. This preparation includes comprehensive cleaning to remove debris and surface dust, followed by careful adjustment of moisture content. Pre-treatment conditions are maintained at a temperature of 20±2° C. with relative humidity between 40-60%. Surface conditioning may be performed when required by specific seed types or conditions.

The coating may be applied through two primary methods: spray application or drum coating.

The spray application process may utilize a twin-fluid atomizer with spray pressure maintained between 2-3 bar. The optimum distance for spray application is 15-20 cm, with a coverage rate of 10-15 mL/kg seeds.

Alternatively, drum coating may be performed at speeds of 15-20 rpm for batch sizes ranging from 5 -25 kg, with an application rate of 20-30 mL/minute and a total coating time of 15-20 minutes.

### Performance Characteristics

The coating demonstrates consistent physical characteristics critical to its performance. Coating thickness is maintained within a range of 20-50 μm, with uniformity variation of ±5 μm and surface roughness less than 2 μm. The mechanical properties of the coating include tensile strength of 15-20 MPa, elongation at break of 200-300%, and adhesion strength exceeding 2 N/mm².

The moisture barrier properties of the coating may be characterized by a water vapor transmission rate below 50 g/m²/day, with moisture content stability maintained within ±2% and humidity resistance up to 85% RH. The antimicrobial efficacy of the coating demonstrates bacterial reduction exceeding 99.9% and fungal inhibition greater than 95%, with protection duration extending beyond 24 months under proper storage conditions.

### Storage and Stability

Storage Conditions Optimal storage conditions are established to maximize coating and seed stability. Temperature requirements specify an optimal range of 5-10° C., with an acceptable range of 0-25° C. and fluctuation tolerance of ±3°C. Humidity requirements stipulate optimal conditions of 40-50% RH, with maximum allowable humidity of 60% RH and minimum of 30% RH.

The coated seeds demonstrate exceptional stability characteristics, with a minimum shelf life of 24 months and optimal conditions supporting stability up to 36 months while maintaining germination rates above 90%. The coating mixture itself exhibits stability in working solution for 48 hours and in concentrated form for 6 months, with pH stability maintained within ±0.2 units.

### EXAMPLES

### Example 1

### Preparation and Characterization

A representative batch of the seed coating composition was prepared according to the described method. PHBV (40% w/w) was dissolved in an appropriate solvent at 65° C. with constant stirring. Chitosan solution was prepared separately and added to achieve a final concentration of 20% w/w. The remaining components were incorporated sequentially with continuous monitoring of physical parameters. The resulting coating demonstrated all specified physical and chemical characteristics.

### Example 2

Performance Testing: Coated seeds were subjected to accelerated aging tests under varying temperature and humidity conditions. Germination studies demonstrated maintenance of viability above 90% after 24 months of storage. Stability testing of the coating showed consistent physical properties and antimicrobial efficacy throughout the study period.

Field Trials Field trials were conducted across multiple geographical locations and climate conditions. Treated seeds showed an average 15% increase in germination rate compared to untreated controls. Plant vigor and early growth characteristics were significantly improved, with enhanced resistance to soil-borne pathogens.

This coating technology represents a significant advancement in sustainable agricultural technology, providing superior seed protection and enhanced germination characteristics while maintaining complete environmental compatibility and regulatory compliance.

Although the field of the disclosure has been described herein with limited reference to specific embodiments, this description is not meant to be construed in a limiting sense. Various modifications of the disclosed embodiments, as well as alternate embodiments of the disclosure, will become apparent to persons skilled in the art upon reference to the description of the disclosure.

What is claimed is:

1. A biodegradable seed coating composition; wherein the seed coating composition comprises of:
a. at least one biopolymer present in the range of 35-45% by weight;
b. natural antimicrobial agent present in the range of 15-25% by weight;
c. plant-derived growth promoters present in the range of 18-24% by weight;
d. micronutrient complex present in the range of 7-10% by weight;
e. additives present in the range of 7-13% by weight;
f. a carrier;
g. Optionally a naturally colorant; and
h. emulsifiers.

2. The composition of claim 1, wherein the biopolymer is selected from the group consisting of polyhydroxyalkanoates (PHA), including polyhydroxybutyrate (PHB), polyhydroxyvalerate (PHV), polyhydroxybutyrate-co-valerate (PHBV), polyhydroxyhexanoate (PHHX), polyhydroxyoctanoate (PHO), polyhydroxyundecanoate (PHU), polyhydroxybutyrate-co-hexanoate (PHBHHX) and polyhydroxybutyrate-cohexadecanoate(PHBHD) or combination thereof.

3. The composition of claim 1, wherein the preferred biopolymer is Polyhydroxybutyrate-co-valerate (PHBV).

4. The composition of claim 1, wherein the natural antimicrobial agent comprises of polysaccharides; wherein polysaccharides consists of chitosan, alginate, agar, xanthum gum, gum Arabic or derivatives or their combination thereof.

5. The composition of claim 1, wherein plant-derived growth promoter is selected from the group consisting of aloe vera extract, moringa extract, agave extract or equivalent substances or a combination thereof.

6. The composition of claim 1, wherein the plant-derived growth promoters include aloe vera extract standardized to 0.5-1% aloin content and water-soluble nitrogen compounds with more than 40% amino acid content.

7. The composition of claim 1, wherein the micronutrient complex comprises of magnesium sulfate in the range of 4-6% by weight, zinc oxide in the range of 1-3% by weight and borax in the range of 0.5-1.5% by weight.

8. The composition of claim 1, wherein the carrier is purified water.

9. The composition of claim 1, wherein the additives consists of natural humectant, antioxidants and combination thereof.

10. The composition of claim 1, wherein natural humectant consists of groups selected from biobased products including Propanediol, Sorbitol, Aloe vera gel, Betaine, Hyaluronic acid, Honey extract, Trehalose, Vegetable glycerol from corn or coconut. or combination thereof.

11. The composition of claim 1, wherein antioxidants consists of groups selected from Tocopherol, Rosemary extract, Caffeic acid, Polyphenols extracts derived green tea, Citric acid, Ferulic acid extracts derived from cereals, Flavonoids including quercetin, Anthocyanins extracts derived from berries and other plants.

12. The composition of claim 1, wherein the additives comprises of a natural humectant which may include (4-6%) derived from vegetable glycerin, antioxidant complex (2-4%), wherein the antioxidant consist of L-ascorbic acid as the primary antioxidant with mixed tocopherols and a bio-based emulsifier (1-3%), derived from sustainable plant.

13. The composition of claim 1, wherein composition further includes natural colorant; wherein natural colorant is selected from group consist of Chlorophyll, Beta-carotene, Curcumin, Anthocyanins, Beetroot extract, Paprika extract including capsanthin, Spirulina extract, Saffron extract, Carmine extracts and other plant-based extracts.

14. The composition of claim 1, wherein composition further includes colorant wherein the colorant is chlorophyll which is added optionally as a natural dye so that the seeds are visually identified.

15. The composition as claimed in claim 1, wherein the emulsifier consists of biodegradable emulsifiers including lecithin, saponins, sugar esters, vegetable-based Mono-and diglycerides of fatty acids, rhamnolipids, guar gum, gum Arabic, pectin, Xanthan gum, Quillaja extracts, Soybean protein, faba bean protein and other biopolymers made of proteins and polysaccharides or combination thereof.

16. A process for manufacturing the seed coating composition of claim 1, is comprising the steps of:
a) Preparing a bio-polymer base solution under controlled temperature;
b) Integrating antimicrobial agents under specific shear conditions;
c) Adding growth promoters sequentially;
d) Incorporating micronutrients in a staged process; and
e) Homogenizing the final mixture under defined pressure and temperature conditions.

17. The process for manufacturing seed coating compositions is comprising the steps of:
a) dissolving chitosan in a 1-2% acetic acid solution to form a chitosan solution using stabilized aloe vera juice as a plant-derived growth promoter
b) dissolving PHBV (polyhydroxybutyrate-valerate) in solvent followed by homogenization to form a polymer base solution;
c) stirring the chitosan solution into the PHBV solution to form a homogeneous mixture, after which stabilized aloe vera juice is added and homogenized for 10 minutes to ensure uniform distribution;
d) stirring nitrogen fertilizer and micronutrients until all solids are completely dissolved; mixing humectants and antioxidants to regulate moisture and protect the composition from degradation, and an emulsifier is added to stabilize the mixture;
e) homogenizing the mixture for 20 minutes to achieve a uniform consistency, after which the resulting composition is filled into airtight, UV-protected containers and stored at room temperature.

18. The process of claim 17, wherein solvent consists a group of ethyl acetate, ethyl ester (acetyl acetate), Triethyl citrate, Butyl acetate or Isopropanol (IPA).

19. The process of claim 17, wherein the manufacturing process maintains temperatures below 70° C. throughout.

20. A coated seed product comprising:
a) an agricultural seed; and
b) the seed coating composition of claim 1 which is applied to the surface of seed as claimed in claim 1.

21. The coated seed product of claim 13, wherein the product exhibits a shelf life of 5-7 years under controlled storage conditions; germination rate maintenance above 90% and moisture stability within ±2%.
